(19) United States
(12) Patent Application Publication
(10) Pub. No.: US 2023/0012843 A1
(43) Pub. Date: Jan. 19, 2023

(54) INFORMATION PROCESSING APPARATUS

(71) Applicant: HITACHI ASTEMO, LTD., Hitachinaka-shi, Ibaraki (JP)

(72) Inventors: Sakie KOMATSU, Ibaraki (JP); Hiroaki ITO, Ibaraki (JP); Koji MAEDA, Ibaraki (JP)

(73) Assignee: HITACHI ASTEMO, LTD., Hitachinaka-shi, Ibaraki (JP)

(21) Appl. No.: 17/786,680

(22) PCT Filed: Dec. 15, 2020
(86) PCT No.: PCT/JP2020/046662

§ 371 Date: Jun. 17, 2022

(30) Foreign Application Priority Data
Jan. 30, 2020 (JP) 2020-013448

(51) Int. Cl. G06V 10/82; G06N 3/04; G06N 5/04; G06V 10/75

(52) U.S. Cl. CPC G06V 10/82; G06N 3/04; G06N 5/04; G06V 10/751

(57) ABSTRACT

An autonomous driving system for a vehicle reduces the amount of computations for object extraction carried out by a DNN, using information a traveling environment or the like. An information processing apparatus including a processor, a memory, and an arithmetic unit that executes a computation using an inference model is provided. The information processing apparatus includes a DNN processing unit that receives external information, the DNN processing unit extracting an external object from the external information, using the inference model, and a processing content control unit that controls processing content of the DNN processing unit. The DNN processing unit includes an object extracting unit that executes the inference model in a deep neural network having a plurality of layers of neurons, and the processing content control unit includes an execution layer determining unit that determines the layers used by the object extracting unit.

### TECHNICAL FIELD

The present invention relates to an information processing apparatus using a deep neural network.

### BACKGROUND ART

In recent years, a technique has been developed, by which a vehicle is controlled to autonomously travel to a destination through peripheral recognition, automatic steering, and automatic speed control, using machine learning. In addition, a deep neural network (DNN) is known today as a machine learning method applied to object recognition or the like.

The DNN executes a learning process of acquiring an object's features and an inference process of extracting an object from image data, based on learning results. In a conventional case where automatic driving of a vehicle is performed using the DNN, image data of the external environment is acquired from a camera and is converted into a data format processable to the DNN. In the inference process, the converted image data is treated as an input image and an object is extracted therefrom, using a DNN having completed the learning process in advance. Thereafter, a surrounding environment map is generated from object extraction results, and an action plan is made, based on the surrounding environment map, to control the vehicle.

PTL 1 discloses a technique by which an object is extracted from an input image from a camera, using a neural network or the like, and whether a space ahead is a space where the vehicle can travel is determined. PTL 2 discloses a technique by which the number of pixels of an input image from a camera is reduced step by step in accordance with a traveling state.

### CITATION LIST

### Patent Literature

PTL 1: JP 2019-008796 A

PTL 2: JP 2018-056838 A

### SUMMARY OF INVENTION

### Technical Problem

The DNN repeatedly executes convolution operations including multiplications and additions. The amount of computations by the DNN, therefore, turns out to be enormous. Particularly, because autonomous driving of a vehicle requires keeping an action plan updated within very short time spans, object extraction by the DNN needs high-speed computation performance. For these reasons, when the DNN is installed in a graphics processing unit (GPU), a field programmable gate array (FPGA), a microcomputer, a CPU, or the like, which are arithmetic units that can be incorporated in a vehicle, power consumption and heat generation by the arithmetic unit amount to very large one.

Besides, to continue autonomous driving in any situation, object extraction with high precision is essential. It is therefore necessary to use an input image with a large number of pixels, in which case a large amount of power consumption and heat generation results when the input image is converted. Because electric power the vehicle can provide is limited, an increase in power consumption and heat generation leads to a problem that in the case of an electric vehicle, its mileage becomes shorter and that the cooling cost of the arithmetic units increases.

However, PTL 1 does not consider the necessity of reducing power consumption in both processes of input image conversion and object extraction. PTL 2 allows a reduction in power consumption in the image conversion process, by changing a method of converting the input image in accordance with a traveling environment. PTL 2, however, does not consider power consumption in the inference process using the DNN requiring a particularly large amount of computations, and is therefore not expected to offer a sufficient power consumption reduction effect.

The present invention has been conceived in view of the above points, and an object of the present invention is to determine whether an object extraction process by a DNN can be omitted, based on a computation load state of an arithmetic unit and on a traveling environment, and to reduce a computation load and power consumption of the arithmetic unit and suppress heat generation of the arithmetic unit as well.

### Solution to Problem

The present invention provides an information processing apparatus including a processor, a memory, and an arithmetic unit that executes a computation using an inference model. The information processing apparatus includes: a DNN processing unit that receives external information, the DNN processing unit extracting an external object from the external information, using the inference model; and a processing content control unit that controls processing content of the DNN processing unit. The DNN processing unit includes an object extracting unit that executes the inference model in a deep neural network having a plurality of layers of neurons, and the processing content control unit includes an execution layer determining unit that determines the layers used by the object extracting unit.

### Advantageous Effects of Invention

The information processing apparatus of the present invention reduces the amount of computations of the deep neural network (DNN), based on a traveling environment, thus being able to reduce power consumption of the arithmetic unit and suppress heat generation of the arithmetic unit while ensuring precision in object extraction by the DNN, the precision being required for autonomous driving. This allows an increase in the mileage of the electric vehicle and a reduction in the cost of a cooling system.

Details of at least one embodiment of the subject matter disclosed herein will be provided in the accompanying drawings and the description below. Other features, aspects, and effects of the disclosed subject matter will be made clear through the following descriptions, drawings, and claims.

### BRIEF DESCRIPTION OF DRAWINGS

FIG. 1 depicts a first embodiment of the present invention, showing a block diagram of an example of a configuration of an autonomous driving system.

FIG. 2 depicts the first embodiment of the present invention, showing a part of a process of carrying out object extraction using a DNN.

FIG. 3 depicts a second embodiment of the present invention, showing a block diagram of an example of a configuration of the autonomous driving system.

FIG. 4 depicts a third embodiment of the present invention, showing a block diagram of an example of a configuration of the autonomous driving system.

FIG. 5 depicts a fourth embodiment of the present invention, showing a block diagram of an example of a configuration of the autonomous driving system.

FIG. 6 depicts a fifth embodiment of the present invention, showing a block diagram of an example of a configuration of the autonomous driving system.

FIG. 7 depicts a sixth embodiment of the present invention, showing a block diagram of an example of a configuration of the autonomous driving system.

FIG. 8 depicts a seventh embodiment of the present invention, showing a block diagram of an example of a configuration of the autonomous driving system.

FIG. 9 depicts the seventh embodiment of the present invention, showing a part of a process of carrying out object extraction.

FIG. 10 depicts an eighth embodiment of the present invention, showing a block diagram of an example of a configuration of the autonomous driving system.

FIG. 11 depicts the eighth embodiment of the present invention, showing an image from a camera of a vehicle traveling in a tunnel.

FIG. 12 depicts a ninth embodiment of the present invention, showing a block diagram of an example of a configuration of the autonomous driving system.

FIG. 13 depicts a tenth embodiment of the present invention, showing a block diagram of an example of a configuration of the autonomous driving system.

FIG. 14 depicts an eleventh embodiment of the present invention, showing a block diagram of an example of a configuration of the autonomous driving system.

FIG. 15 depicts a twelfth embodiment of the present invention, showing a block diagram of an example of a configuration of the autonomous driving system.

### DESCRIPTION OF EMBODIMENTS

Embodiments will hereinafter be described with reference to the drawings.

### First Embodiment

A deep neural network (hereinafter “DNN”) having a plurality of layers of neurons repeatedly executes convolution operations including multiplications and additions. The amount of computations of the deep neural network, therefore, turns out to be enormous. As a result, power consumption and heat generation by an arithmetic unit that executes the DNN amounts to large one. When an information processing apparatus of a vehicle carries out an object extraction process, using the DNN, therefore, such a problem arises that in the case of an electric vehicle, its mileage gets shorter or that cooling cost increases.

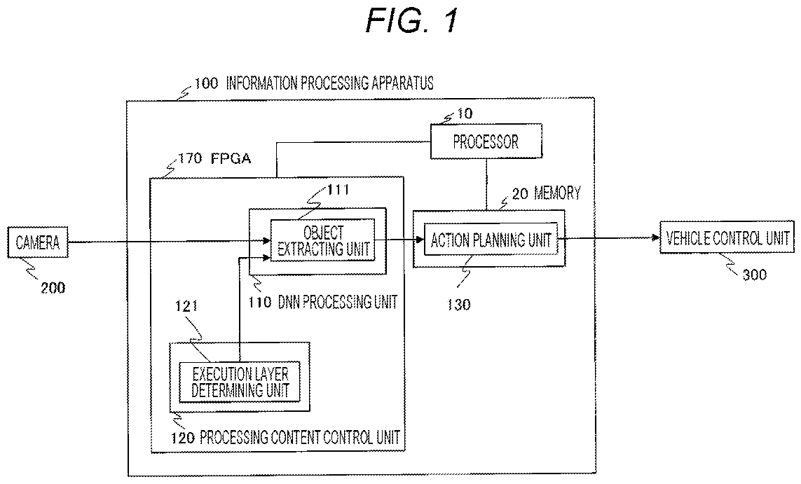

FIG. 1 is a block diagram of an example of a configuration of an autonomous driving system using an information processing apparatus 100 according to a first embodiment.

As shown in FIG. 1, the autonomous driving system using the information processing apparatus 100 according to this embodiment includes the information processing apparatus 100, a camera 200, and a vehicle control unit 300. The information processing apparatus 100 is a computer including a processor 10, a memory 20, and a field programmable gate array (FPGA) 170.

This embodiment is described as an example in which the FPGA 170 is adopted as an arithmetic unit that executes the DNN. It should be noted, however, that the embodiment is not limited to this example and a graphics processing unit (GPU) may be adopted as the arithmetic unit. The arithmetic unit that executes the DNN may be housed in the same package in which the processor 10 is housed. The processor 10 and the FPGA 170 are connected to the camera 200 and the vehicle control unit 300 via an interface (not illustrated).

In the memory 20, an action planning unit 130 is loaded as a program and is executed by the processor 10. The processer 10 executes a process according to a program of each functional unit, thereby working as a functional unit that provides a given function. For example, the processor 10 executes a process according to an action planning program, thus functioning as the action planning unit 130. The processor 10 also processes other programs in the same manner. Further, the processor 10 works also as a functional unit that provides respective functions of a plurality of processes executed by each program. A computer and a computer system are an apparatus and a system that include these functional units.

The FPGA 170 includes a DNN processing unit 110 and a processing content control unit 120. The FPGA 170 includes the action planning unit 130. The DNN processing unit 110 includes an object extracting unit 111. The processing content control unit 120 includes an execution layer determining unit 121. The camera 200 may or may not be included in the information processing apparatus 100. The information processing apparatus 100 may or may not be incorporated in the vehicle.

Processes by the DNN processing unit 110 will first be described. The object extracting unit 111 holds a DNN (inference model) used for an inference process that ensues a learning process carries out by a PC or server. The FPGA 170 processes external information (image data) acquired by the camera 200 to extract an object from the image data, using a DNN reflecting information outputted from the processing content control unit 120.

The camera 200, which is attached at a given position (not illustrated) on the vehicle, acquires an image of a space in front of the vehicle, as external information for detecting an object outside (in front of) the vehicle, and outputs the image to the information processing apparatus 100.

The action planning unit 130 creates an action plan for setting a traveling direction, a traveling speed, and the like of the vehicle, using information on an object extracted by the object extracting unit 111, and outputs the action plan to the vehicle control unit 300. The vehicle control unit 300 controls the vehicle, based on output from the action planning unit 130. The vehicle control unit 300 carries out its processes by applying known techniques. Processes carried out by the vehicle control unit 300, therefore, will not be described in detail in this embodiment.

Processes by the processing content control unit 120 will then be described. The execution layer determining unit 121 holds the number of execution layers of the DNN used in the object extraction process, and outputs information on the number of execution layers to the object extracting unit 111.

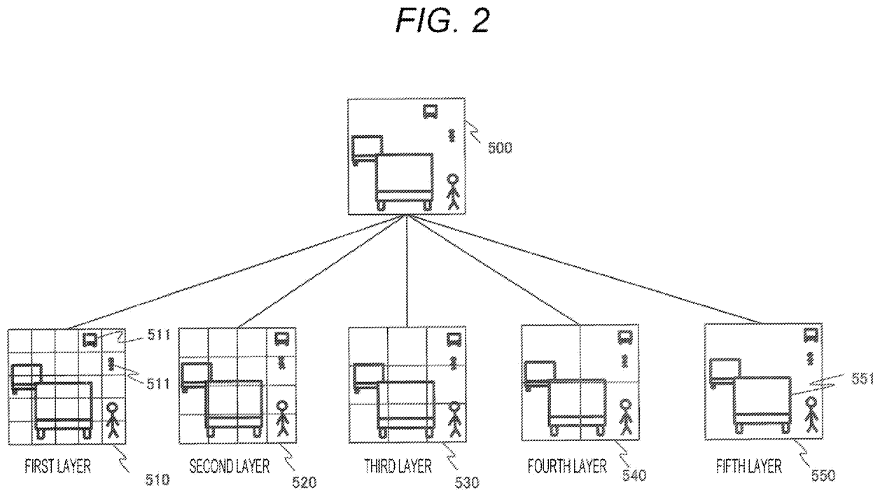

Processes by the object extracting unit 111 will hereinafter be described, using a specific example. In the object extraction process using the DNN, an object is extracted by applying a plurality of layers different in the number of segmentations to external information (image data). This allows extraction of objects of various sizes. FIG. 2 depicts an example of an excerpt of a part of a process that the object extracting unit 111 shown in FIG. 1 carries out to extract an object from information (image data) from the camera 200, using the DNN.

In FIG. 2, a camera image 500 is an example of an image outputted from the camera 200 shown in FIG. 1. An image 510 shows an example of segmenting the camera image 500 in a first layer of the DNN of the object extracting unit 111, and images 520, 530, 540, and 550 show patterns of segmenting the camera image 500 in a second layer, a third layer, a fourth layer, and a fifth layer, respectively.

FIG. 2 demonstrates that in the first layer, the DNN processing unit 110 extracts a small object 511, such as a distant person or car, by segmenting the camera image 500 into small blocks, and that in the fifth layer, the DNN processing unit 110 extracts a large object 551, such as a car nearby, by segmenting the camera image 500 into a large block.

In the image 510, the DNN processing unit 110 segments the input image (500) into 5×5=25 blocks, and the object extracting unit 111 carries out the object extraction process in each unit of blocks. Similarly, the DNN processing unit 110 segments the input mage into 4×4=16 blocks in the image 520, into 3×3=9 blocks in the image 530, into 2×2=4 blocks in the image 540, and into 1×1=1 block in the image 550, and carries out the object extraction process in respective units of blocks

Hence the number of times the DNN processing unit 110 carries out the object extraction processes on the image shown in FIG. 2 amounts to 25+16+94 4+1=55 times. It should be noted that the structure of the DNN is not limited to the structure adopted in this embodiment in which a small object is extracted first and then a large object is extracted. Any structure that allows object extraction may be adopted. In addition, the number of segmentation blocks and the number of layers that are used in computation by the DNN are not limited to the number of them indicated in FIG. 2. Any number of blocks and layers that ensures precision necessary for achieving autonomous driving may be adopted.

For example, in the case of a vehicle or the like that travels on a road in a private land, such as a factory, the road providing fine visibility and letting limited types of vehicles run on the road, at a speed sufficiently lower than a speed with which the vehicle runs on an ordinary road, extracting a distant small object several hundred meters ahead is unnecessary. In this case, the number of blocks where the object extraction process is carried out may be reduced by reducing the number of layers of the DNN.

For example, the execution layer determining unit 121 determines DNN layers to be executed in the object extraction process to be the second layer to the fifth layer, which do not include the first layer for extracting the smallest object, and sends an instruction indicating the determined second layer to the fifth layer, to the object extracting unit 111. Based on this information from the execution layer determining unit 121, the object extracting unit 111 executes only the second layer to the fifth layer of the DNN to carry out the object extraction process. In this case, the number of times of carrying out object extraction processes is 16+9+4+1=30 times, which is 25 times fewer than the case where object extraction is carried out in the entire layers, and therefore computations in 25 times of processes can be reduced.

At the start of traveling, the execution layer determining unit 121 sets layers to be executed in advance according to a travel environment or the like, and sends an instruction indicating the set layers to the object extracting unit 111, as a processing condition.

In this manner, by reducing the DNN layers (fixed value) used by the object extracting unit 111, for example, power consumption of arithmetic units, such as the FPGA 170 and the GPU, can be reduced and heat generation of the same can be suppressed as well. This results in an increases in the mileage of the electric vehicle and a reduction in the cooling cost of the arithmetic units.

It should be noted that in the above description, the number of DNN layers and the number of blocks shown in FIG. 2 are values used for simpler explanation, and that in the DNN used for actual object extraction, external information is segmented into several thousands to several tens of thousands of blocks, and numbers of layers are included. The actual number of computations is, therefore, far greater than those in the above example, in which case an effect of reducing the amount of computations, the effect being achieved by reducing the number of layers, turns out to be far greater, too.

In this embodiment, the camera 200 is adopted as a sensor that acquires external information. The sensor is, however, not limited to the camera 200 and may be provided as any sensor capable of acquiring the distance to an object or the type of an object, such as a light detection and ranging (LiDAR), a radio detection and ranging (RADAR), or a far infrared camera. In addition, the sensor may be provided as a single sensor or a combination of sensors.

In the first embodiment, an example of the object extracting unit 111 that executes an inference model generated by the DNN-based machine learning has been described. The inference model, however, is not limited to this, and a model generated by a different type of machine learning may also be used.

### Second Embodiment

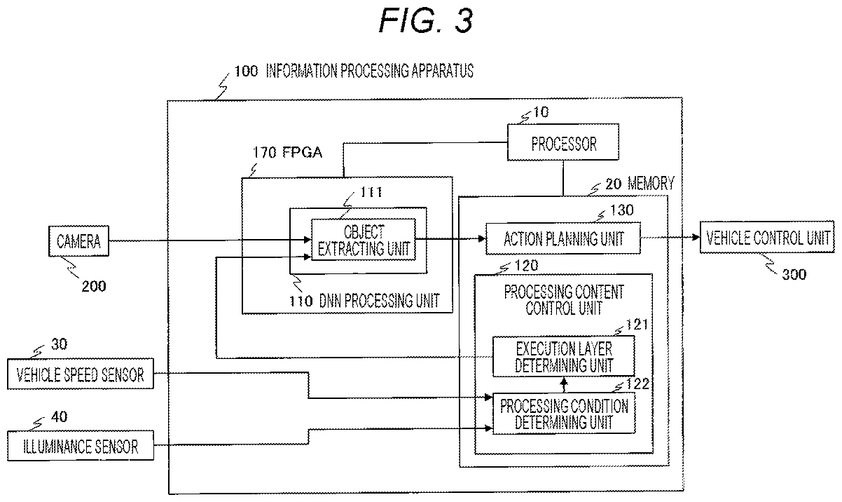

A second embodiment of the present invention will hereinafter be described. FIG. 3 is a block diagram of an example of a configuration of the autonomous driving system using an information processing apparatus 100 according to the second embodiment. In FIG. 3, the same constituent elements as shown in FIG. 1 are denoted by the same names and reference signs, and, unless otherwise specified, will be omitted in further description on the assumption that they have the same or similar functions as shown in FIG. 1.

The second embodiment is an example in which a processing condition determining unit 122 and sensors that detect external state information are added to the first embodiment, and the execution layer determining unit 121 is transferred from the FPGA 170 into the processing content control unit 120 outside the FPGA 170. In other aspects of the configuration, the second embodiment is the same as the first embodiment.

In FIG. 3, the processing condition determining unit 122 newly added to the first embodiment determines the current traveling environment, using input information indicating a traveling state, the input information coming from of a sensor or the like of the vehicle being running. Based on the traveling environment determined by the processing condition determining unit 122, the execution layer determining unit 121 dynamically changes the number of DNN layers (processing condition) used in the object extraction process.

In this embodiment, a vehicle speed sensor 30 and an illuminance sensor 40 are connected to the information processing apparatus 100, as sensors that detect a traveling state of the vehicle. A means for detecting the traveling state of the vehicle, however, is not limited to these sensors. What is needed is to detect at least a vehicle speed, and the vehicle speed may be calculated from positional information provided by a global positioning system (GPS).

The processing condition determining unit 122 of the information processing apparatus 100 determines the travel environment from information from the vehicle speed sensor 30 and the illuminance sensor 40, and outputs the determined travel environment to the execution layer determining unit 121. Based on the inputted travel environment, the execution layer determining unit 121 determines layers to be used in the DNN, as a processing condition, and sends an instruction indicating the processing condition to the object extracting unit 111.

The first embodiment is an example in which the execution layer determining unit 121 is disposed in the FPGA 170 because the number of layers (processing condition) is a fixed value. In the second embodiment, in contrast, the execution layer determining unit 121 dynamically changes the number of layers (processing condition). For this reason, the execution layer determining unit 121 is loaded onto the memory 20 as a program, and is executed by the processor 10.

The first embodiment is described as an example in which execution layers of the DNN are statically determined in a limited traveling environment. However, in autonomous driving of the vehicle, the traveling environment varies and is complicated, and the precision of an object extracted from image data changes from moment to moment. It is therefore desirable that the execution layers of the DNN be changed dynamically according to the traveling environment.

A process by the processing condition determining unit 122 will hereinafter be described, using a specific example.

An example in which a vehicle speed detected by the vehicle speed sensor 30 is used as information indicating a traveling state will be presented as one example. An example will be described in which the processing condition determining unit 122 determines that the current traveling environment is a congested environment when finding that a vehicle speed detected by the vehicle speed sensor 30 is equal to or lower than a preset vehicle speed threshold.

In a case where the vehicle is traveling at a very low speed (e.g., 5 km/h) in a traffic jam, a change in an incoming image from the camera 200 is small. The object extracting unit 111 in this case, therefore, only needs to recognize an object several tens of meters ahead, and does not have to carry out object extraction with precision high enough to recognize an object several hundred meters ahead.

The execution layer determining unit 121 determines a processing condition, based on a traveling environment determined by the processing condition determining unit 122. The execution layer determining unit 121 determines the second layer (520) to the fifth layer (550), which do not include the first layer (the image 510 in FIG. 2) for detecting the smallest object, to be the DNN layers to be executed by the object extracting unit 111, i.e., the processing condition so that the amount of computations of the DNN can be reduced as the precision of object extraction necessary for autonomous driving is ensured.

As described above, according to the second embodiment, the sensors that detect the traveling state and the processing condition determining unit 122 that determines the traveling environment of the vehicle from information indicating the traveling state are added to the configuration of the first embodiment, and the execution layer determining unit 121 determines the processing condition suitable for the traveling environment. As a result, in comparison with the first embodiment, the information processing apparatus 100 of the second embodiment can dynamically change the processing condition in accordance with the traveling environment, the processing condition affecting the object extraction precision and the power consumption and heat generation of the arithmetic unit (FPGA 170).

It is thus expected that the mileage of the electric vehicle is increased to be longer than that in the first embodiment and that the cooling cost of the arithmetic unit (FPGA 170) is reduced. The above means for determining the congested traveling environment may not be the vehicle speed sensor 30, and may be image information indicative of a traveling speed or traffic jam information provided by a radio, the Internet, and the like.

In addition, the illuminance sensor 40 is used as a sensor that provides information indicating the traveling state, and the processing condition determining unit 122 concludes a state of traveling in nighttime when finding that the surrounding brightness (illuminance) is equal to or lower than a preset illuminance threshold. At night, the vehicle surroundings is dark, and the camera 200 cannot acquire detailed external information that can be acquired when the surroundings are bright. In this case, because external information that allows extraction of an object several hundred meters ahead is unobtainable, the object extracting unit 111 carries out computation with precision that allows extraction of an object several tens of meters ahead, and does not need to carry out object extraction with precision that allows recognition of an object several hundred meters ahead.

In this case, based on the traveling environment determined by the processing condition determining unit 122, the execution layer determining unit 121 determines the DNN layers to be executed by the object extracting unit 111 to be the second layer (520) to the fifth layer (550). Information indicating the traveling state for determining the current surrounding brightness is not limited to information from the illuminance sensor 40. For example, whether it is daytime or nighttime may be determined based on information from a sensor capable of detecting brightness around the camera 200 or from a device that provides time information, such as a radio, the Internet, or a GPS.

An in-vehicle camera (not illustrated) may also be used as a unit that provides information indicating the traveling state. In this case, the processing condition determining unit 122 determines whether the driver is operating the steering wheel, based on image data from the in-vehicle camera, and when finding that the driver is operating the steering wheel, determines that autonomous driving (AD) is not in execution. When AD is executed, the vehicle is under controlled by the automatic driving system only, in which case object extraction with precision high enough to allow recognition of a small object is necessary. When AD is not executed, however, the driver recognizes information on the external environment by himself or herself, in which case ensuring object extraction precision that allows driving assistance (advanced driver assistance systems or ADAS) is enough.

Based on the traveling environment determined by the processing condition determining unit 122, the execution layer determining unit 121 determines the DNN layers to be executed by the object extracting unit 111 to be the second layer (520) to the fifth layer (550).

The unit that provides Information based on which the processing condition determining unit 122 determines whether AD is in execution is not limited to the in-vehicle camera. Any unit that allows determining whether the driver is in the driver's seat, such as a sensor that detects the driver's operating the steering wheel, may provide such information. Furthermore, whether AD is in execution may be determined from data indicating the presence or absence of an action plan for autonomous driving, the action plan being created by the action planning unit 130.

The processing condition determining unit 122 may determine the processing condition, using any one of pieces of information indicating the traveling state or using a plurality of the same.

### Third Embodiment

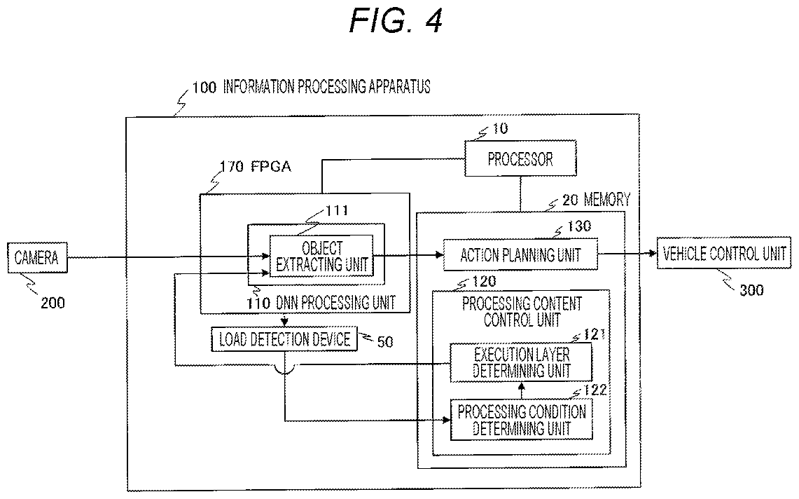

A third embodiment of the present invention will hereinafter be described. FIG. 4 is a block diagram of an example of a configuration of the autonomous driving system using an information processing apparatus 100 according to a third embodiment. In FIG. 4, the same constituent elements as shown in FIG. 3 are denoted by the same names and reference signs, and, unless otherwise specified, will be omitted in further description on the assumption that they have the same or similar functions as shown in FIG. 3.

The third embodiment is an example in which the processing condition determining unit 122 and a load detection device 50 are added to the first embodiment and the execution layer determining unit 121 is transferred from the FPGA 170 to the processing content control unit 120 outside the FPGA 170.

In other aspects of the configuration, the second embodiment is the same as the first embodiment.

In the second embodiment, the processing condition determining unit 122 determines the current traveling environment, using input information indicating the travel state, the input information coming from the sensor or the like of the vehicle being running. In the third embodiment, the processing condition determining unit 122 in the information processing apparatus 100 determines a current load state of the FPGA 170, using a computation load of the object extracting unit 111 as input information. Based on the load state determined by the processing condition determining unit 122, the execution layer determining unit 121 determines the number of DNN layers (processing condition) to be used by the object extracting unit 111.

In FIG. 4, the load detection device 50 newly added to the first embodiment detects a computation load of the FPGA 170, and outputs the detected computation load to the processing condition determining unit 122. The load detection device 50 may include, for example, a sensor that detects power consumption, supply current, and the like of the FPGA 170, as a computation load.

The first embodiment is the example in which the execution layer determining unit 121 is disposed in the FPGA 170 because the number of layers (processing condition) is a fixed value. In the third embodiment, in contrast, the execution layer determining unit 121 dynamically changes the number of layers (processing condition). For this reason, the execution layer determining unit 121 is loaded onto the memory 20 as a program, and is executed by the processor 10.

A process by the processing condition determining unit 122 will hereinafter be described, using a specific example.

For example, the processing condition determining unit 122 calculates a load factor of the FPGA 170, as a computation load, and compares the load factor with a given load factor threshold. For example, a value (%) given by dividing power consumption detected by the load detection device 50 by prescribed maximum power is used as the load factor.

When the load factor of the FPGA 170 is higher than the load factor threshold, the processing condition determining unit 122 determines that reducing the computation load of the FPGA 170 is necessary. Based on the determination result from the processing condition determining unit 122, the execution layer determining unit 121 determines the DNN layers used by the object extracting unit 111 to be the second layer (520) to the fifth layer (550), which do not include the first layer (510) for detecting the smallest object, so that the load factor of the FPGA 170 becomes equal to or lower than the load factor threshold.

In this manner, the processing condition determining unit 122 that determines the load state from the computation load of the FPGA 170 is added to the first embodiment. As a result, the processing condition determining unit 122 determines the load state corresponding to the load factor of the FPGA 170 included in the information processing apparatus 100, and the execution layer determining unit 121 can dynamically change the processing condition according to the determined load state. Hence the information processing apparatus 100 can dynamically reduce power consumption of the FPGA 170 and suppress heat generation of the FPGA 170 as well, which is an advantage over the first embodiment.

In addition, the information processing apparatus 100 of this embodiment with the above advantages prevents a problem with the FPGA 170 caused by thermal runaway or the like, thus being able to prevent a drop in the computation precision of the arithmetic unit. Hence, compared with the first embodiment, the mileage of the electric vehicle can be increased as the cooling cost of the FPGA 170 and the like can be reduced.

The load factor of the FPGA 170, which is defined as the computation load in this embodiment, is not limited to power consumption. The temperature or the like of the FPGA 170 may also be used as a value related to the computation load. Computation loads may include not only the load factor of the FPGA 170 but also a computation load of the processor 10.

The processing condition determining unit 122 may determine the load state, using any one of computation loads or using a plurality of computation loads.

### Fourth Embodiment

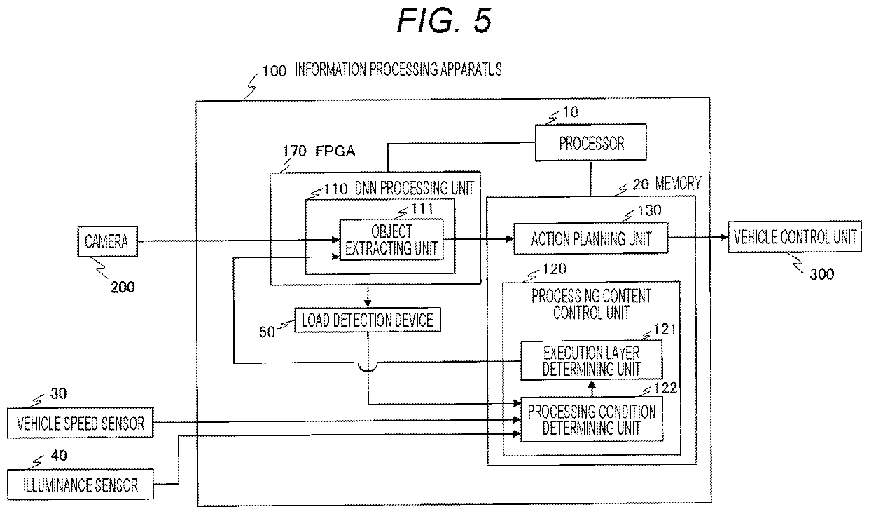

A fourth embodiment of the present invention will then be described. FIG. 5 is a block diagram of an example of a configuration of the autonomous driving system using an information processing apparatus 100 according to a fourth embodiment. In FIG. 5, the same constituent elements as shown in FIGS. 3 and 4 are denoted by the same names and reference signs, and, unless otherwise specified, will be omitted in further description on the assumption that they have the same or similar functions as shown in FIGS. 3 and 4.

The fourth embodiment is an example in which the configuration of the third embodiment is added to the configuration of the second embodiment. In other aspects of the configuration, the fourth embodiment is the same as the second embodiment.

In the second embodiment, the current traveling environment is determined using input information indicating the traveling state, the input information coming from the sensor or the like of the vehicle being running, while in the third embodiment, the current load state is determined using the computation load of the information processing apparatus 100, as input information. The fourth embodiment is an example in which the second embodiment and the third embodiment are combined together.

The processing condition determining unit 122 determines a traveling environment and a load state, using both information indicating a traveling state and a computation load of the FPGA 170, as input information, and outputs the determination result to the execution layer determining unit 121. Based on the determination result from the processing condition determining unit 122, the execution layer determining unit 121 determines the number of DNN layers (processing condition) used by the object extracting unit 111.

In this manner, the processing condition determining unit 122 determines the traveling environment and the load state, using the information indicating the traveling state and the computation load of the FPGA 170. Through this process, compared with the second and third embodiments, object extraction precision and reduction of power consumption and heat generation can be changed dynamically.

It is thus expected that the resulting effects combine advantages of the second and third embodiments. In other words, it is possible that the load of the FPGA 170 is kept in a normal state as proper object extraction precision is maintained in various traveling environments.

The processing condition determining unit 122 may determine the processing condition, using either the information indicating the traveling state or the computation load or using both of them.

### Fifth Embodiment

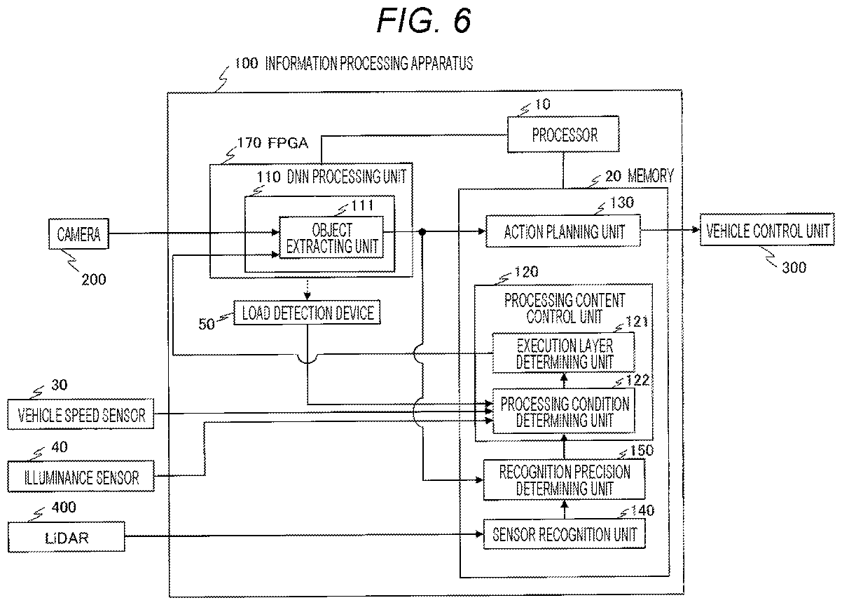

A fifth embodiment of the present invention will hereinafter be described. FIG. 6 is a block diagram of an example of a configuration of the autonomous driving system using an information processing apparatus 100 according to the fifth embodiment. In FIG. 6, the same constituent elements as shown in FIG. 5 are denoted by the same names and reference signs, and, unless otherwise specified, will be omitted in further description on the assumption that they have the same or similar functions as shown in FIG. 5.

The fifth embodiment includes a LiDAR 400, a recognition sensor unit 140, and a recognition precision determining unit 150 that are added to the constituent elements of the fourth embodiment. In other aspects of the configuration, the fifth embodiment is the same as the fourth embodiment.

In FIG. 6, the recognition sensor unit 140 newly added to the fourth embodiment processes information (distance and bearings) from the LiDAR 400 to recognize an object. The recognition precision determining unit 150 determines whether object extraction by the object extracting unit 111 maintains required precision by examining a difference between an object extraction result from the object extracting unit 111 and an object recognition result from the recognition sensor unit 140, and outputs the determination result to the processing condition determining unit 122.

The processing condition determining unit 122 then updates a reference value serving as a condition for reducing a computation load of the object extracting unit 111, based on the determination result from the recognition precision determining unit 150, a traveling state, and a computation load, thereby preventing excessive omission of computations that makes object extraction precision insufficient due to the excessively reduced computation load.

In the information processing apparatus 100 of the first, second, third, and fourth embodiments, the reference value for controlling the number of DNN layers used by the object extracting unit 111, the reference value being determined according to the information indicating the traveling state and the computation load, is static. It is desirable, however, that to maintain object extraction precision required for autonomous driving, the reference value be dynamic.

A process by the recognition precision determining unit 150 will hereinafter be described, using a specific example.

A case is assumed where, for example, the object extracting unit 111, to which image data from the camera 200 is inputted, extracts 5 objects, while the recognition sensor unit 140, which processes information from the LiDAR 400, recognizes 7 objects, so that the number of objects extracted by the object extracting unit 111 is smaller than the number of objects recognized by the recognition sensor unit 140.

In this case, because the extracting unit 111 has failed to extract objects recognized by the recognition sensor unit 140, the recognition precision determining unit 150 determines that the object extracting unit 111 does not maintain the object extraction precision required for autonomous driving.

Based on information from the object extracting unit 111 and the recognition sensor unit 140, the recognition precision determining unit 150 outputs an instruction to the processing condition determining unit 122, the instruction instructing the processing condition determining unit 122 to change a processing condition in such a way as to improve the object extraction precision, and the processing condition determining unit 122 changes the reference value for determining the processing condition.

The recognition precision determining unit 150 may calculate a value given by dividing the number of objects extracted by the object extracting unit 111 by the number of objects recognized by the recognition sensor unit 140, as recognition precision, and when finding that the calculated recognition precision is equal to or lower than a preset precision threshold, may determine that the recognition precision has dropped and output the determination result to the processing condition determining unit 122.

In a case where the reference value in this embodiment is, for example, used as a value for correcting the load factor threshold, when the processing condition determining unit 122 receives an instruction to improve the object extraction precision, from the recognition precision determining unit 150, the processing condition determining unit 122 increases the reference value by 5% to increase the load factor threshold. The processing condition determining unit 122 then notifies the execution layer determining unit 121 of the load factor threshold having been increased.

Upon receiving the notification of the load factor threshold having been increased, the execution layer determining unit 121 adds a given value to the number of DNN layers currently used by the object extracting unit 111, and sends an instruction indicating addition of the given value to the number of DNN layers, to the object extracting unit 111 of the FPGA 170. The given value added by the execution layer determining unit 121 is, for example, one layer.

In this manner, in response to a request from the recognition precision determining unit 150, the execution layer determining unit 121 increases the number of DNN layers used by the object extracting unit 111 to improve precision in extracting an object.

However, when the traveling environment is a congested environment or a nighttime situation, the effect of increasing the number of DNN layers used by the object extracting unit 111 is low, in which case the execution layer determining unit 121 may cancel the notification of the load factor threshold having been increased.

In this manner, by additionally providing the recognition sensor unit 140 that recognizes an object, based on information from the LiDAR 400, and the recognition precision determining unit 150 that determines the precision of object extraction by the object extracting unit 111 and the recognition sensor unit 140, excessive reduction in computation processes (layers), the excessive reduction making the object extraction precision required for autonomous driving insufficient at the object extracting unit 111, can be prevented.

As a result, the information processing apparatus 100 of the fifth embodiment can maintain processing with precision higher than the precision of processing in the first, second, third, and fourth embodiments. Hence the information processing apparatus 100 of this embodiment can further reduce power consumption than the information processing apparatus 100 of the first, second, third, and fourth embodiments.

This embodiment is an example in which a sensor used for determining the object extraction precision is the LiDAR 400. This sensor may be any sensor that can determine the distance to or the type of an object, such as a camera, a RADAR, a far-infrared camera, and that is different from a sensor that outputs external information to the object extracting unit 111, and is therefore not limited to the LiDAR. In addition, the sensor may be provided as a single sensor or a combination of sensors.

In this embodiment, the method by which the recognition precision determining unit 150 determines the object extraction precision is a static process of determining whether the extraction result from the object extracting unit 111 matches the recognition result from the recognition sensor unit 140. However, by giving the recognition precision determining unit 150 a learning function, the reference for determining the object extraction precision may be changed dynamically.

### Sixth Embodiment

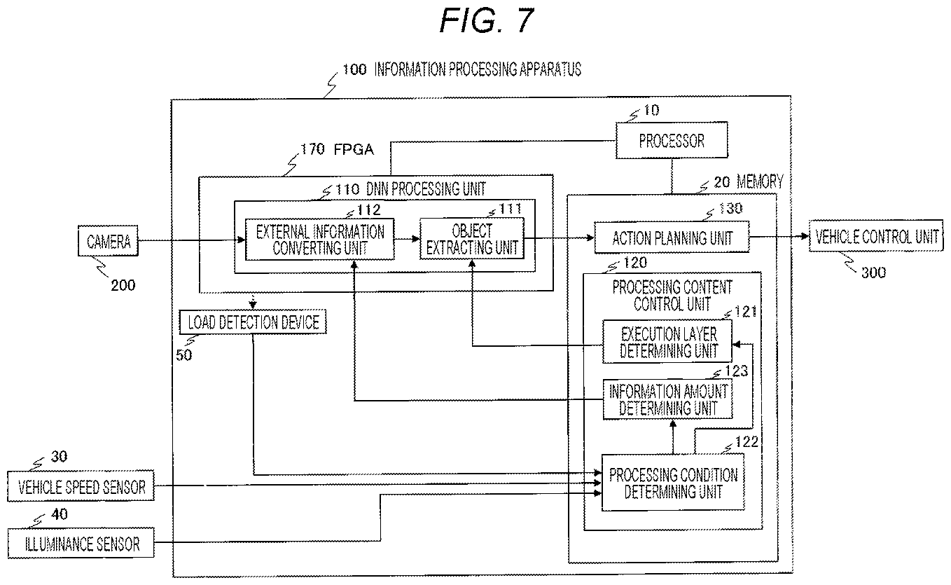

A sixth embodiment of the present invention will hereinafter be described. FIG. 7 is a block diagram of an example of a configuration of the autonomous driving system using an information processing apparatus 100 according to the sixth embodiment. In FIG. 7, the same constituent elements as shown in FIG. 5 are denoted by the same names and reference signs, and, unless otherwise specified, will be omitted in further description on the assumption that they have the same or similar functions as shown in FIG. 5.

The sixth embodiment is an example in which an information amount determining unit 123 is added to the processing content control unit 120 of the fourth embodiment shown in FIG. 5 and an external information converting unit 112 is added to the DNN processing unit 110, and the number of pixels (or resolution) of an external environment image inputted from the camera 200 is changed according to a traveling environment and a load state. In other aspects of the configuration, the sixth embodiment is the same as the fourth embodiment.

With reference to FIG. 7, the information amount determining unit 123 and the external information converting unit 112 that are newly added to the fourth embodiment will be described. Based on a determination result from the processing condition determining unit 122, the information amount determining unit 123 determines the number of pixels (resolution) of an external environment image acquired by the camera 200, the external environment image being inputted to the object extracting unit 111, and sends an instruction indicating the number of pixels, to the external information converting unit 112 of the FPGA 170.

Based on the instruction from the information amount determining unit 123, the external information converting unit 112 converts the format of the external environment image acquired by the camera 200 into a format that can be used by the DNN. As a result, the object extracting unit 111 carries out object extraction with the number of pixels matched to a processing condition (the number of layers).

In the first, second, third, and fourth embodiments, the sizes of objects extracted in respective layers (510 to 550) by the object extracting unit 111 vary, and therefore the required number of pixels (resolution) of the external environment image varies as well, depending on the processing content of each layer of the object extracting unit 111. It is therefore desirable that the number of pixels of the image inputted to the object extracting unit 111 be dynamically changed according to the number of layers used in the object extraction process.

A process by the external information converting unit 112 will hereinafter be described, using a specific example.

A case is assumed where, for an example, the camera 200 outputs an image composed of 2 million pixels. It is also assumed that based on a determination result from the processing condition determining unit 122, the information amount determining unit 123 determines the number of pixels necessary for object extraction to be 250,000 pixels.

In this case, the external information converting unit 112 converts the image outputted from the camera 200 in format such that its 2 million pixels are reduced into 250,000 pixels. The object extracting unit 111 extracts an object, using the image composed of 250,000 pixels that is outputted from the external information converting unit 112.

In this manner, the DNN processing unit 110 dynamically changes the number of pixels of the input image to the object extracting unit 111, based on the determination result from the processing condition determining unit 122, thus being able to use the image of which the number of pixels is matched to the number of execution layers of the DNN used by the object extracting unit 111. Thus, the number of execution layers of the DNN is reduced and the number of pixels of the image to the object extracting unit 111 is reduced as well, which, therefore, allows a reduction in the amount of computations.

As a result, the information processing apparatus 100 of this embodiment can reduce power consumption and suppress heat generation more effectively than in the first, second, third, and fourth embodiments. Hence the information processing apparatus 100 of this embodiment, compared with the first, second, third, and fourth embodiments, is expected to offer an effect that the mileage of the electric vehicle is further increased and the cooling cost of the FPGA 170 and the like is further reduced.

In this embodiment, the information amount determining unit 123 changes the number of pixels of the image from the camera 200. What is required is, however, to change (reduce) the amount of external information, which is not limited to the number of pixels. For example, if the unit that outputs external information is LiDAR or RADAR, the number of point groups is changed, as the amount of external information.

### Seventh Embodiment

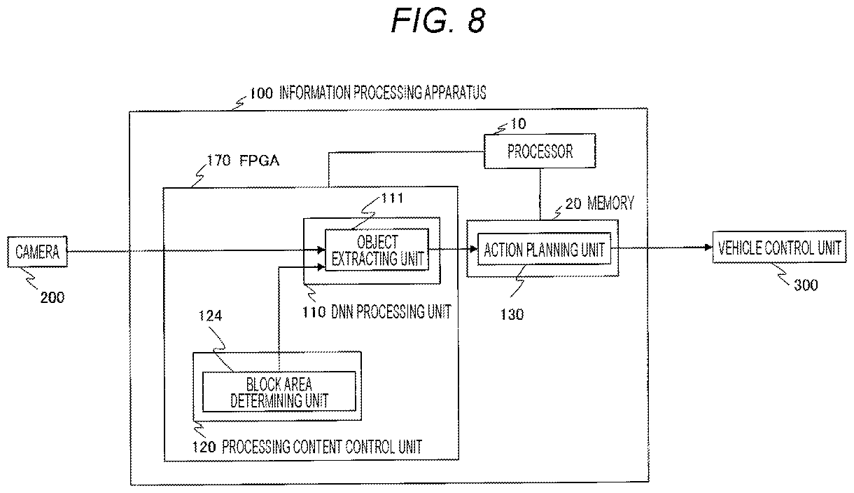

FIG. 8 is a block diagram of an example of a configuration of the autonomous driving system using an information processing apparatus 100 according to a seventh embodiment. In FIG. 8, the same constituent elements as shown in FIG. 1 are denoted by the same names and reference signs, and, unless otherwise specified, will be omitted in further description on the assumption that they have the same or similar functions as shown in FIG. 1.

The seventh embodiment is an example in which the execution layer determining unit 121 of the first embodiment is replaced with a block area determining unit 124. In other aspects of the configuration, the second embodiment is the same as the first embodiment.

The newly added block area determining unit 124 shown in FIG. 8 holds a block area in which the object extraction process of the DNN is executed, and outputs information of the block area to the object extracting unit 111. The block area determining unit 124 of this embodiment holds a preset area as a fixed block area.

Processes by the object extracting unit 111 will hereinafter be described, using a specific example.

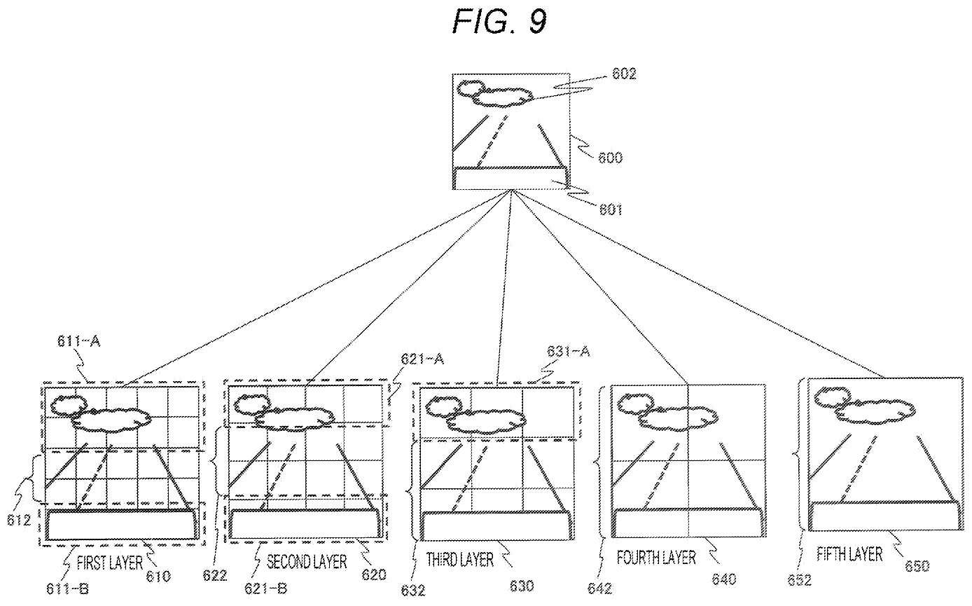

FIG. 9 depicts an example of an excerpt of a process that the object extracting unit 111 shown in FIG. 8 carries out to extract an object from image data inputted from the camera 200, using the DNN.

In FIG. 9, a camera image 600 is a camera image outputted from the camera 200 in FIG. 8. An image 610 shows a state of segmentation of the camera image 600 in the first layer of the DNN for the object extracting unit 111, an image 620 shows a state of segmentation in the second layer, an image 630 shows a state of segmentation in the third layer, an image 640 shows a state of segmentation in the fourth layer, and an image 650 shows a state of segmentation in the fifth layer.

In the image 610, the DNN processing unit 110 segments the camera image 600 into 5×5=25 blocks, and the object extracting unit ill carries out the object extraction process in units of blocks. Similarly, the DNN processing unit 110 segments the camera image 600 into 4×4=16 blocks in the image 620, into 3×3=9 blocks in the image 630, into 2×2=4 blocks in the image 640, and into 1×1=1 block in the image 650, and carries out the object extraction process in respective units of blocks

Hence the number of times that the DNN of the first layer to the fifth layer shown in FIG. 9, the DNN making up the object extracting unit 111, carries out the object extraction processes amounts to 25+16+9+4+1=55 times. The structure of the DNN of the object extracting unit 111 is not limited to the structure used in this embodiment in which a small object is extracted first and then a large object is extracted. Any structure in which an object can be extracted from the camera image 600 may be used as the structure of the DNN. The number of segmented blocks and the number of layers that are adopted at DNN computation are not limited to the numbers shown in FIG. 9. Any number of blocks and layers that ensure precision required for achieving autonomous driving may be adopted.

Now there is a case where, as shown in FIG. 9, the camera image 600 from the camera 200 may include such an object as the vehicle's hood or the sky 601. These objects are objects that do not need to be extracted from the camera image 600 when control of the vehicle is carried out. For this reason, the object extracting unit 111 may specify a block area in which the DNN is executed, thereby skipping the object extraction process in a block area including the image of unnecessary objects only.

For example, in FIG. 9, in a case where the vehicle exclusively travels on a flat road with good visibility, the camera image 600 carries an images of an object unnecessary for autonomous driving (cloud or hood) that constantly stays in the same place. In this case, carrying out the object extraction process in the block area including such an object is unnecessary. The object extracting unit 111 carries out the object extraction process only in the area specified as the block area in which the DNN is executed.

In the case of FIG. 9, an area in which the object extraction process is not executed is specified as an exclusion area, and an area in which the object extraction process is executed is specified as a block area.

In the image 610 of the first layer of the object extracting unit 111, an area in which only the sky appears in the camera image 600 is specified as an exclusion area 611-A, and an area in which only the hood appears in the camera image 600 is specified as an exclusion area 611-B. When an exclusion area is specified but areas of the sky and the hood are not specified in particular, such an exclusion area is expressed as “611” by omitting “-A” and “-B”. This notation applies also to other exclusion areas.

The area between the exclusion area 611-A and the exclusion area 611-B is specified as a block area 612. Specifically, in the first layer, the object extracting unit 111 executes object extraction using the DNN, in the block area 612 containing the third and fourth columns from the top of the image 610.

In the image 620 of the second layer, the object extracting unit 111 specifies an area of camera image 600 that carries only the image of the sky, as an exclusion area 621-A, and specifies an area of camera image 600 that carries only the image of the hood, as an exclusion area 621-B.

Then, the area between the exclusion area 621-A and the exclusion area 621-B is specified as a block area 622. In the second layer, the object extracting unit 111 executes object extraction using the DNN, in the block area containing the second and third columns from the top of the image 620.

In the image 630 of the third layer, the object extracting unit 111 specifies an area of camera image 600 that carries only the image of the sky, as an exclusion area 631-A. Then, the area other than the exclusion area 631-A is specified as a block area 632. In the third layer, the object extracting unit 111 executes object extraction using the DNN, in the block area 632 containing the second and third columns from the top of the image 660.

In the image 640 of the fourth layer and the image 620 of the fifth layer, their entire areas are specified as a block area 642 and a block area 652, respectively, and therefore object extraction using the DNN is executed in the entire blocks.

In this manner, the exclusion area 611 in which the object extraction process is not executed is set in advance in the block area determining unit 124. As a result, the number of times of DNN computations amounts to 9+8+6+4+1=28 times, which is 27 times fewer than the number of times of DNN computations in the case where object extraction is carried out in the entire block areas of the camera image 600.

In this embodiment, by skipping the DNN computation process by the object extracting unit 111 in the fixed exclusion areas of the camera image 600, for example, power consumption of the arithmetic units, such as the FPGA 170 and the GPU, can be reduced and heat generation of the same can be suppressed as well. As a result, the mileage of the electric vehicle is increased, and the cooling cost of the arithmetic units, such as the FPGA 170, is reduced.

It should be noted that in this embodiment, the number of DNN layers and the number of blocks shown in FIG. 9 are values used for simpler explanation, and that in the DNN used for actual object extraction, external information, i.e., the camera image 600 is segmented into several thousands to several tens of thousands of blocks, and numbers of layers are included. The actual number of computations is, therefore, far greater than those in the above example, in which case an effect of reducing the amount of computations, the effect being achieved by reducing the block areas in which computations are executed, turns out to be far greater, too.

In this embodiment, external information is acquired by the camera 200, but the unit that acquires external information is not limited to the camera 200. The unit that acquires external information, for example, may be any sensor capable of acquiring the distance to an object or the type of an object, such as a LiDAR, a RADAR, or a far infrared camera. In addition, the sensor may be provided as a single sensor or a combination of sensors.

The block area determining unit 124, which determines the block areas where the DNN of the object extracting unit 111 executes object extraction, may reduce the number of layers in the same manner as the number of layers is reduced in the first, second, third, fourth, fifth, and sixth embodiments. In this case, the number of DNN layers as well as the number of blocks used by the object extracting unit 111 is reduced, which allows further reduction in power consumption.

### Eighth Embodiment

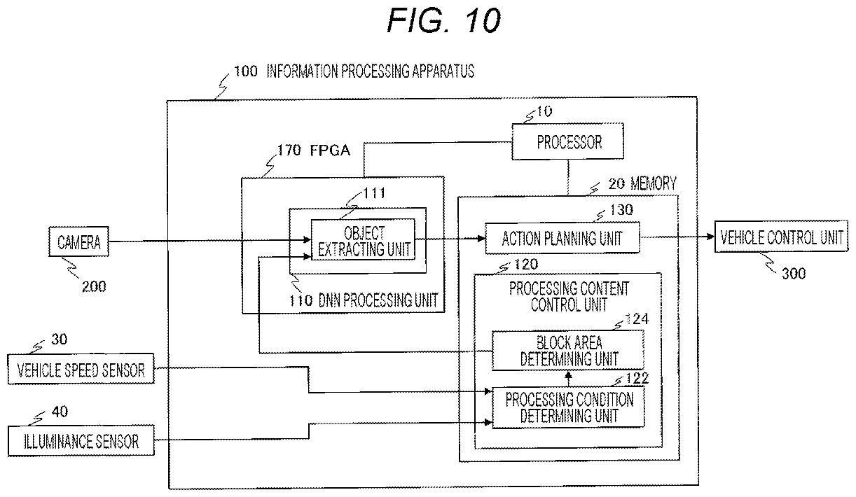

An eighth embodiment of the present invention will hereinafter be described. FIG. 10 is a block diagram of an example of a configuration of the autonomous driving system using an information processing apparatus 100 according to the eighth embodiment. In FIG. 10, the same constituent elements as shown in FIG. 8 are denoted by the same names and reference signs, and, unless otherwise specified, will be omitted in further description on the assumption that they have the same or similar functions as shown in FIG. 8.

This embodiment is an example in which the processing condition determining unit 122 and sensors are added to the seventh embodiment, and the block area determining unit 124 is transferred from the FPGA 170 into the processing content control unit 120. In other aspects of the configuration, the eighth embodiment is the same as the seventh embodiment.

In FIG. 10, the processing condition determining unit 122 newly added to the seventh embodiment determines the current traveling environment, using input information indicating a traveling state, the input information coming from a sensor or the like of the vehicle being running. Based on the traveling environment determined by the processing condition determining unit 122, the block area determining unit 124 dynamically changes the block areas (612, 622, 632, 642, and 652 in FIG. 9) in which the DNN is executed by the object extraction process

This embodiment is an example in which the vehicle speed sensor 30 and the illuminance sensor 40 are connected to the information processing apparatus 100, as the sensors that detect the traveling state of the vehicle in the same manner as in the second embodiment. The sensors are, however, are not limited to the vehicle speed sensor 30 and the illuminance sensor 40.

In the same manner as in the second embodiment, the processing condition determining unit 122 of the information processing apparatus 100 determines the traveling environment, based on information from the vehicle speed sensor 30 and the illuminance sensor 40, and outputs the determined travel environment to the block area determining unit 124. Based on the incoming travel environment, the block area determining unit 124 determines a block area used by the DNN (or an exclusion area), as a processing condition, and sends an instruction indicating the processing condition, to the object extracting unit 111.

The seventh embodiment is an example in which, because the block area is a fixed value, the block area determining unit 124 is disposed in the FPGA 170. In the eighth embodiment, on the other hand, the block area determining unit 124 dynamically changes the block areas (or the exclusion areas). For this reason, the execution layer determining unit 121 is loaded onto the memory 20 as a program and is executed by the processor 10.

The seventh embodiment is an example in which the block area where the DNN is executed in the limited traveling environment is statically determined. In autonomous driving of the vehicle, however, the traveling environment varies and is complicated as the precision of object extraction from image data changes from moment to moment. It is therefore desirable that the block area (or the exclusion area) where the DNN is executed be dynamically changed according to the traveling environment.

A process by the processing condition determining unit 122 will hereinafter be described, using a specific example.

An example in which a vehicle speed detected by the vehicle speed sensor 30 is used as information indicating a traveling state will be presented as one example. When the vehicle speed detected by the vehicle speed sensor 30 is equal to or lower than a preset vehicle speed threshold, the processing condition determining unit 122 determines that the current traveling environment is a congested environment.

In a case where the vehicle is traveling at a very low speed (e.g., 5 km/h) in a traffic jam, a change in an input image from the camera 200 is small. In this case, the object extracting unit 111 only needs to have object extraction precision that allows the vehicle to follow a different vehicle running ahead thereof, and executing object extraction in the entire areas of the image from the camera 200 is unnecessary.

The block area determining unit 124 determines a processing condition, based on the traveling environment determined by the processing condition determining unit 122. The block area determining unit 124 determines the processing condition for reducing the amount of DNN computations while securing the object extraction precision required for autonomous driving, thus determining (specifying) exclusion areas 611, 621, and 631 in which object extraction is not carried out and block areas 612, 622, 632, 642, and 652 in which object extraction is carried out using the DNN, both areas being shown in FIG. 9.

The object extracting unit 111 carries out object extraction only in the block areas 612, 622, 632, 642, and 652 determined by the block area determining unit 124. Areas in an image may be simply specified as block areas and exclusion areas.

As described above, according to the eighth embodiment, the processing condition determining unit 122, which determines the external environment (traveling environment) from information indicating the traveling state, is added to the configuration of the seventh embodiment, and the processing condition suitable for the traveling environment is determined. As a result, compared with the information processing apparatus 100 of the seventh embodiment, the information processing apparatus 100 of the eighth embodiment can dynamically change the object extraction precision and the power consumption and heat generation of the FPGA 170 in accordance with the traveling environment.

It is therefore expected that, compared with the seventh embodiment, the mileage of the electric vehicle is increased and the cooling cost of the FPGA 170 is reduced. The above means for determining the congested traveling environment may not be the vehicle speed sensor 30, and may be image information indicative of a traveling speed or traffic jam information provided by a radio, the Internet, and the like.

In addition, the illuminance sensor 40 is used as a sensor that provides information indicating the traveling state, and the processing condition determining unit 122 determines the traveling environment to be traveling inside a tunnel when the surrounding brightness (illuminance) is equal to or lower than a preset illuminance threshold.

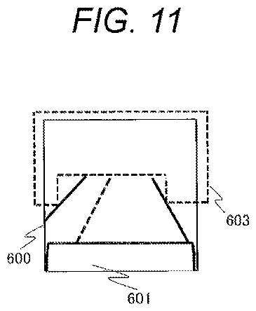

FIG. 11 depicts an example in which the object extracting unit 111 carries out DNN processing in an area of the camera image 600 from the camera 200 of the vehicle traveling in a tunnel. Because the tunnel interior is surrounded by walls, the left and right ends of the camera image 600 does not need to be subjected to the object extraction process.

When a determination result from the processing condition determining unit 122 indicates the vehicle being in a tunnel, the block area determining unit 124 determines an exclusion area 603 in which object extraction is not carried out, as shown in FIG. 11. As a method of determining the current traveling environment to be traveling in a tunnel, a device capable of specifying the current position, such as a GPS, can be used.

The block area determining unit 124 may instruct the object extracting unit 111 to specify an area where no (or a little) change arises between frames of the camera image 600, as the exclusion area 603.

An in-vehicle camera (not illustrated) may also be used as a unit that provides information indicating the traveling state. In this case, the processing condition determining unit 122 determines whether the driver is operating the steering wheel, based on image data from the in-vehicle camera, and when finding that the driver is operating the steering wheel, determines that autonomous driving (AD) is not in execution. When AD is executed, the vehicle is under controlled by the automatic driving system only, in which case object extraction with precision high enough to allow recognition of a small object is necessary. When AD is not executed, however, the driver recognizes information on the external environment by himself or herself, in which case ensuring object extraction precision that allows driving assistance (advanced driver assistance systems or ADAS) is enough.

Based on the traveling environment determined by the processing condition determining unit 122, the block area determining unit 124 determines a block area in which the DNN is executed by the object extracting unit 111. Alternatively, the block area determining unit 124 may determine an exclusion area 611 or the like in which the DNN is not executed. A unit different from the in-vehicle camera may be used as the unit by which whether AD is in execution is determined. Whether AD is in execution may be determined by a sensor that detects the driver's operating the steering wheel, a unit that determines whether the driver is in the driver's seat, or data indicating the presence or absence of an action plan for autonomous driving created by the action planning unit 130.

The processing condition determining unit 122 may determine the processing condition, using any one of pieces of information indicating the traveling state or using a plurality of the same.

### Ninth Embodiment

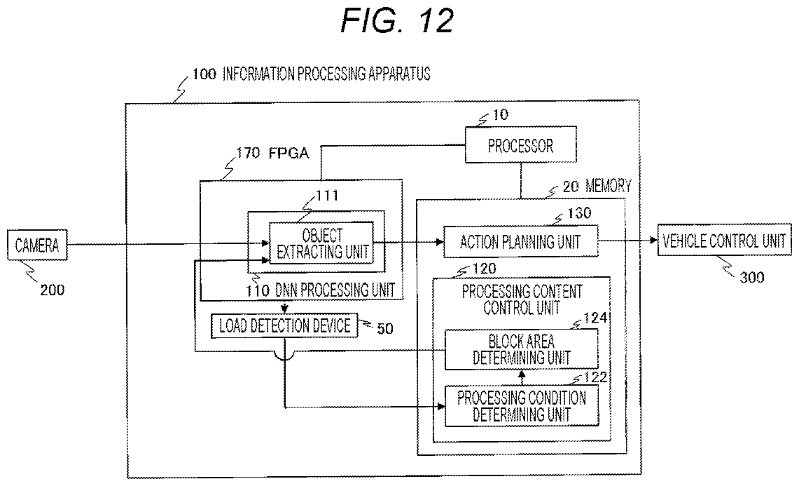

A ninth embodiment of the present invention will hereinafter be described. FIG. 12 is a block diagram of an example of a configuration of the autonomous driving system using an information processing apparatus 100 according to the ninth embodiment. In FIG. 12, the same constituent elements as shown in FIG. 10 are denoted by the same names and reference signs, and, unless otherwise specified, will be omitted in further description on the assumption that they have the same or similar functions as shown in FIG. 10.

The ninth embodiment is an example in which the processing condition determining unit 122 and the load detection device 50 are added to the seventh embodiment, and the block area determining unit 124 is transferred from the FPGA 170 into the processing content control unit 120. In other aspects of the configuration, the eighth embodiment is the same as the seventh embodiment.

In the eight embodiment, the processing condition determining unit 122 determines the current traveling environment, based on the input information indicating the travel state, the input information coming from the sensor or the like of the vehicle being running. In the ninth embodiment, the processing condition determining unit 122 determines the current load state of the FPGA 170, based on a computation load of the information processing apparatus 100, the calculation load being input information. Based on the load state determined by the processing condition determining unit 122, the block area determining unit 124 determines a DNN block area the object extracting unit 111 uses to execute object extraction.

In FIG. 12, the load detection device 50 newly added to the seventh embodiment detects a computation load of the FPGA 170 and inputs the detected computation load to the processing condition determining unit 122. The load detection device 50 may include, for example, a sensor that detects power consumption, supply current, and the like of the FPGA 170, as a computation load.

The seventh embodiment is an example in which, because the block area where the DNN is executed (or the exclusion area) is a fixed value, the block area determining unit 124 is disposed in the FPGA 170. In the ninth embodiment, because the block area determining unit 124 dynamically changes the block area (or the processing condition), the block area determining unit 124 is loaded onto the memory 20 as a program and is executed by the processor 10.

A process by the processing condition determining unit 122 will hereinafter be described, using a specific example.

For example, the processing condition determining unit 122 calculates a load factor of the FPGA 170, as a computation load, and compares the load factor with a given load factor threshold. For example, a value (%) given by dividing power consumption detected by the load detection device 50 by prescribed maximum power is used as the load factor.

When the load factor of the FPGA 170 is higher than the load factor threshold, the processing condition determining unit 122 determines that reducing the computation load of the FPGA 170 is necessary. Based on the determination result from the processing condition determining unit 122, the block area determining unit 124 determines an exclusion area, in which object extraction is not executed by the object extracting unit 111, so that the load factor of the FPGA 170 becomes equal to or lower than the load factor threshold.

The block area determining unit 124 may instruct the object extracting unit 111 to specify an area where no (or a little) change arises between frames of the camera image 600, as the exclusion area 603.

In this manner, by additionally providing the processing condition determining unit 122 that determines the load state from the computation load, the load state corresponding to the load factor of the FPGA 170 included in the information processing apparatus 100 is determined. This allows the execution layer determining unit 121 to dynamically change the processing condition according to the load state. Hence the information processing apparatus 100 can dynamically reduce power consumption of the FPGA 170 and suppress heat generation of the FPGA 170 as well, which is an advantage over the first embodiment.

In addition, because of the above effects, the information processing apparatus 100 of this embodiment can prevent a problem with the FPGA 170 caused by thermal runaway or the like, thus preventing a drop in computation precision. Hence, compared with the first embodiment, the mileage of the electric vehicle can be increased as the cooling cost of the FPGA 170 and the like can be reduced.

The load factor of the FPGA 170, which is defined as the computation load in this embodiment, is not limited to power consumption. The temperature or the like of the FPGA 170 may also be used as a value related to the computation load. Computation loads may include not only the load factor of the FPGA 170 but also a computation load of the processor 10.

The processing condition determining unit 122 may determine the load state, using any one of computation loads or using a plurality of computation loads.

### Tenth Embodiment

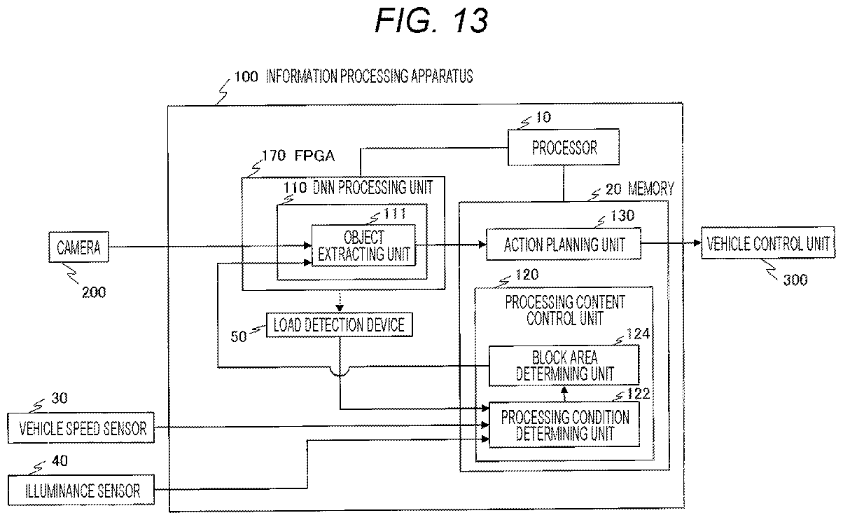

A tenth embodiment of the present invention will hereinafter be described. FIG. 13 is a block diagram of an example of a configuration of the autonomous driving system using an information processing apparatus 100 according to the tenth embodiment. In FIG. 13, the same constituent elements as shown in FIGS. 10 and 12 are denoted by the same names and reference signs, and, unless otherwise specified, will be omitted in further description on the assumption that they have the same or similar functions as shown in FIGS. 10 and 12.

The tenth embodiment is an example in which the configuration of the ninth embodiment is added to the configuration of the eighth embodiment. In other aspects of the configuration, the tenth embodiment is the same as the eighth embodiment.

In the eight embodiment, the current traveling environment is determined based on the input information indicating the traveling state, the input information coming from the sensor or the like of the vehicle being running. In the ninth embodiment, the current load state is determined based on the computation load of the information processing apparatus 100, the computation load being the input information. The tenth embodiment is an example in which the eighth embodiment and the ninth embodiment are combined together.

The processing condition determining unit 122 determines a traveling environment and a load state, using both information indicating a traveling state of the running vehicle and a computation load of the FPGA 170, as input information, and outputs the determination result to the block area determining unit 124. Based on the determination result from the processing condition determining unit 122, the block area determining unit 124 determines a DNN block area (processing condition) used for object extraction. The block area determining unit 124 determines the block area or exclusion area in the same manner as described above.

As described above, in the information processing apparatus 100 of this embodiment, the processing condition determining unit 122 determines the traveling environment and the load state, based on the information indicating the traveling state and on the computation load of the FPGA 170. The information processing apparatus 100 of this embodiment, compared with the information processing apparatus 100 of the eighth and ninth embodiments, is thus able to dynamically change the object extraction precision and the extent of reduction of power consumption and heat generation.

Hence the information processing apparatus 100 of this embodiment is expected to offer an effect combining advantages of the eighth and ninth embodiments. In other words, it is possible that the load of the FPGA 170 is kept in a normal state as proper object extraction precision is maintained in various traveling environments.

The processing condition determining unit 122 may determine the processing condition, using either the information indicating the traveling state or the computation load or using both of them.

### Eleventh Embodiment

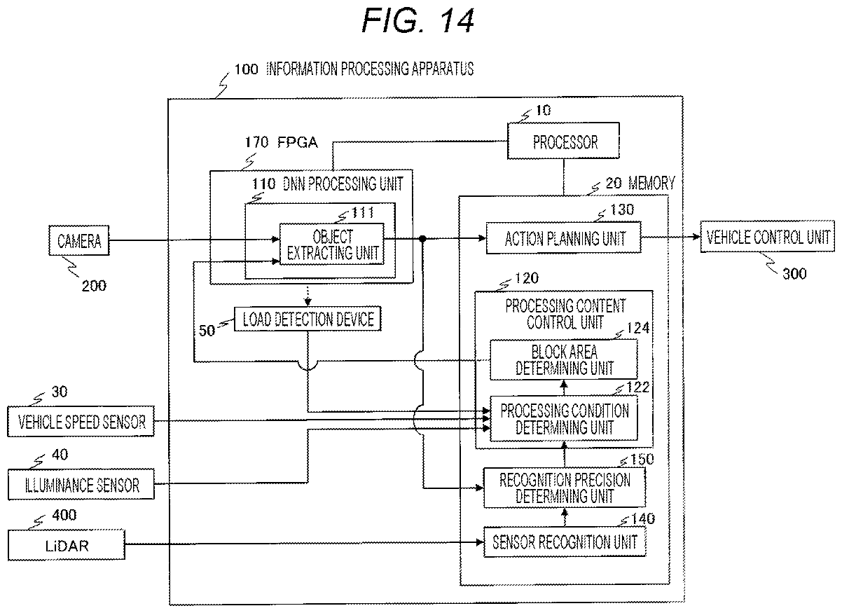

An eleventh embodiment of the present invention will hereinafter be described. FIG. 14 is a block diagram of an example of a configuration of the autonomous driving system using an information processing apparatus 100 according to the eleventh embodiment. In FIG. 14, the same constituent elements as shown in FIG. 13 are denoted by the same names and reference signs, and, unless otherwise specified, will be omitted in further description on the assumption that they have the same or similar functions as shown in FIG. 13.

In the eleventh embodiment, the LiDAR 400, the recognition sensor unit 140, and the recognition precision determining unit 150 are added to the constituent elements of the tenth embodiment. In other aspects of the configuration, the fifth embodiment is the same as the fourth embodiment.

In FIG. 14, the recognition sensor unit 140 newly added to the tenth embodiment processes information (distance and bearings) from the LiDAR 400 to recognize an object. The recognition precision determining unit 150 determines whether object extraction by the object extracting unit 111 maintains required precision by examining a difference between an object extraction result from the object extracting unit 111 and an object recognition result from the recognition sensor unit 140, and outputs the determination result to the processing condition determining unit 122.

The processing condition determining unit 122 then updates a reference value serving as a condition for reducing a computation load, thereby preventing excessive omission of computations that makes object extraction precision insufficient due to the excessively reduced computation load.

The processing condition determining unit 122 then updates a reference value serving as a condition for reducing a computation load of the object extracting unit 111, based on the determination result from the recognition precision determining unit 150, a traveling state, and a computation load, thereby preventing excessive omission of computations that makes object extraction precision insufficient due to the excessively reduced computation load.

In the seventh, eighth, ninth, and tenth embodiments, the block area in which object extraction is executed using the DNN is determined statically, based on the information indicating the traveling state and on the computation load. It is desirable, however, that, to maintain the object extraction precision required for autonomous driving, the reference value be determined dynamically.

A process by the recognition precision determining unit 150 will hereinafter be described, using a specific example.

A case is assumed where, for example, the object extracting unit 111, to which image data from the camera 200 is inputted, extracts 5 objects, while the recognition sensor unit 140, which processes information from the LiDAR 400, recognizes 7 objects, so that the number of objects extracted by the object extracting unit 111 is smaller than the number of objects recognized by the recognition sensor unit 140.

In this case, because the object extracting unit 111 has failed to extract objects recognized by the recognition sensor unit 140, it is determined that the object extracting unit 111 does not maintain the object extraction precision required for autonomous driving.

Based on information from the object extracting unit 111 and the recognition sensor unit 140, the recognition precision determining unit 150 outputs an instruction to the processing condition determining unit 122, the instruction instructing the processing condition determining unit 122 to change a processing condition in such a way as to improve the object extraction precision, and the processing condition determining unit 122 changes the reference value for determining the processing condition.

In a case where the reference value in this embodiment is, for example, used as a value for correcting the load factor threshold, when the processing condition determining unit 122 receives an instruction to improve the object extraction precision, from the recognition precision determining unit 150, the processing condition determining unit 122 increases the reference value by 5% to increase the load factor threshold. The processing condition determining unit 122 then notifies the block area determining unit 124 of the load factor threshold having been increased.

Upon receiving the notification of the load factor threshold having been increased, the block area determining unit 124 adds a given value to the DNN block area currently used by the object extracting unit 111, and sends an instruction indicating addition of the given value to the block area, to the object extracting unit 111 of the FPGA 170. The given value added by the block area determining unit 124 is determined to be, for example, 1.

In this manner, in response to a request from the recognition precision determining unit 150, the block area determining unit 124 increases the number of DNN block areas used by the object extracting unit 111 to improve precision in extracting an object.

However, when the traveling environment is a congested environment or a nighttime situation, the effect of increasing the number of DNN block areas used by the object extracting unit 111 is low, in which case the execution layer determining unit 121 may cancel the notification of the load factor threshold having been increased.

In this manner, by additionally providing the recognition sensor unit 140 that recognizes an object, based on information from the LiDAR 400, and the recognition precision determining unit 150 that determines the precision of object extraction by the object extracting unit 111 and the recognition sensor unit 140, excessive reduction in computation processes (layers), the excessive reduction making the object extraction precision required for autonomous driving insufficient at the object extracting unit 111, can be prevented.

As a result, the information processing apparatus 100 of the eleventh embodiment can maintain processing with precision higher than the precision of processing in the seventh, eighth, ninth, and tenth embodiments. Hence the information processing apparatus 100 of this embodiment can further reduce power consumption of the FPGA 170 than the information processing apparatus 100 of the seventh, eighth, ninth, and tenth embodiments.

In this embodiment, a sensor used for determining the object extraction precision is the LiDAR 400. This sensor may be any sensor that can determine the distance to or the type of an object, such as a camera, a RADAR, and a far-infrared camera, and that is different from a sensor that outputs external information to the object extracting unit 111, and is therefore not limited to the LiDAR. In addition, the sensor may be provided as a single sensor or a combination of sensors.

In this embodiment, the method by which the recognition precision determining unit 150 determines the object extraction precision is a static process of determining whether the extraction result from the object extracting unit 111 matches the recognition result from the recognition sensor unit 140. However, by giving the recognition precision determining unit 150 a learning function, the reference for determining the object extraction precision may be changed dynamically.

### Twelfth Embodiment

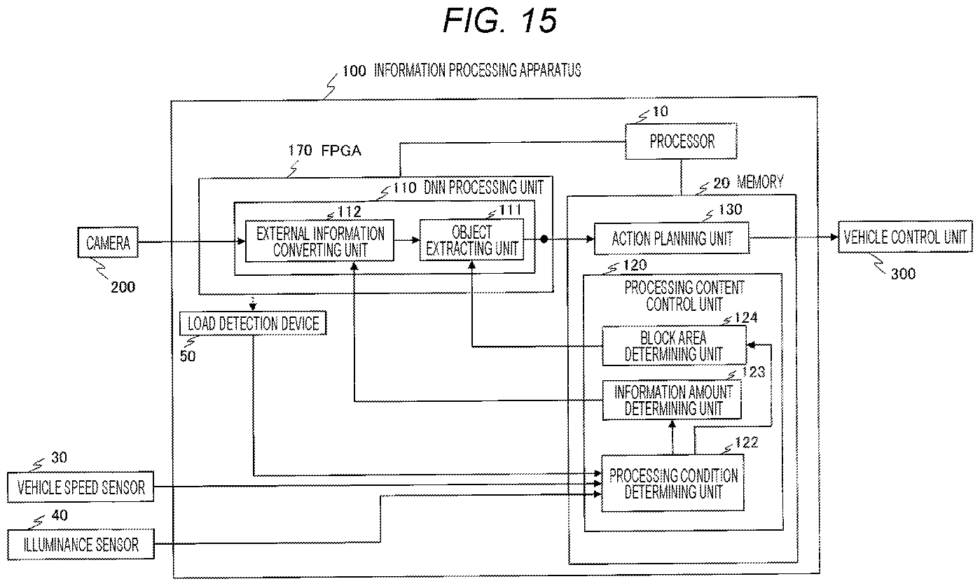

A twelfth embodiment of the present invention will hereinafter be described. FIG. 15 is a block diagram of an example of a configuration of the autonomous driving system using an information processing apparatus 100 according to the twelfth embodiment. In FIG. 15, the same constituent elements as shown in FIG. 13 are denoted by the same names and reference signs, and, unless otherwise specified, will be omitted in further description on the assumption that they have the same or similar functions as shown in FIG. 13.

The twelfth embodiment is an example in which the information amount determining unit 123 and the external information converting unit 112 are added to the processing content control unit 120 and the DNN processing unit 110 of the tenth embodiment shown in FIG. 13, respectively, and the number of pixels (or resolution) of an external environment image inputted from the camera 200 is changed according to a traveling environment or a load state. In other aspects of the configurations, the twelfth embodiment is the same as the tenth embodiment.

The information amount determining unit 123 and the external information converting unit 112 that are newly added to the tenth embodiment will be described with reference to FIG. 15. Based on a determination result from the processing condition determining unit 122, the information amount determining unit 123 determines the number of pixels (resolution) of an external environment image acquired by the camera 200, the external environment image being inputted to the object extracting unit 111, and sends an instruction indicating the number of pixels, to the external information converting unit 112 of the FPGA 170.

Based on the instruction from the information amount determining unit 123, the external information converting unit 112 converts the format of the external environment image acquired by the camera 200 into a format that can be used by the DNN. As a result, the object extracting unit 111 carries out object extraction with the number of pixels matched to a processing condition (the bock area or exclusion area).

A process by the external information converting unit 112 will hereinafter be described, using a specific example.

A case is assumed where, for an example, the camera 200 outputs an image composed of 2 million pixels. It is also assumed that based on a determination result from the processing condition determining unit 122, the information amount determining unit 123 determines the number of pixels necessary for object extraction to be 250,000 pixels. In this case, the external information converting unit 112 converts the image outputted from the camera 200 in format such that its 2 million pixels are reduced into 250,000 pixels. The object extracting unit 111 extracts an object, using the image composed of 250,000 pixels that is outputted from the external information converting unit 112.

In this manner, the information processing apparatus 100 of this embodiment dynamically changes the number of pixels of the input image, based on the determination result from the processing condition determining unit 122, thus being able to use the image of which the number of pixels is matched to the number of block areas where the DNN is executed by the object extracting unit 111. Thus, the number of execution layers of the DNN is reduced and the number of pixels of the image subjected to object extraction by the object extracting unit 111 is reduced as well, which, therefore, allows a reduction in the amount of computations.

As a result, the information processing apparatus 100 of this embodiment can reduce power consumption and suppress heat generation more effectively than in the seventh, eighth, ninth, and tenth embodiments. Hence the information processing apparatus 100 of this embodiment is expected to offer an effect that the mileage of the electric vehicle is increased to be longer than that in the seventh, eighth, ninth, and tenth embodiments and that the cooling cost of the FPGA 170 is reduced.

In this embodiment, the information amount determining unit 123 changes the number of pixels of the image from the camera 200. What is required is, however, to change the amount of external information, which is not limited to the number of pixels. For example, if the unit that outputs external information is LiDAR or RADAR, the number of point groups is changed, as the amount of external information.

<Conclusion> According to the described description, the information processing apparatus 100 of the first to sixth embodiments (seventh to twelfth embodiments) may be configured in the following manner.

(1) An information processing apparatus (100) including a processor (10), a memory (20), and an arithmetic unit (FPGA 170) that executes a computation using an inference model, the information processing apparatus (100) comprising: a DNN processing unit (110) that receives external information (output from a camera 200), the DNN processing unit (110) extracting an external object from the external information, using the inference model; and a processing content control unit (120) that controls processing content of the DNN processing unit (110), wherein the DNN processing unit (110) includes an object extracting unit (111) that executes the inference model in a deep neural network having a plurality of layers of neurons, and wherein the processing content control unit (120) includes an execution layer determining unit (121) that determines the layers used by the object extracting unit (111).

According to the above configuration, the layers of the DNN (fixed value) used by the object extracting unit 111 are reduced. As a result, power consumption of the arithmetic unit, such as the FPGA 170 or the GPU, can be reduced and heat generation of the same can be suppressed as well. This results in an increases in the mileage of the electric vehicle and a reduction in the cooling cost of the arithmetic units.

(2) The information processing apparatus according to (1), wherein the processing content control unit (120) includes a processing condition determining unit (122) that receives external state information (traveling state), the processing condition determining unit (122) comparing a preset threshold with a value of the external state information and determining an external environment, and wherein the execution layer determining unit (121) determines the number of the layers to be used by the DNN processing unit (110), based on a determination result from the processing condition determining unit (122), and outputs the determined number of the layers to the DNN processing unit (110).

According to the above configuration, a sensor that detects a traveling state and the processing condition determining unit 122 that determines a traveling environment for the vehicle, based on information indicating the traveling state, are additionally provided, and the execution layer determining unit 121 determines a processing condition suitable for the traveling environment. As a result, compared with the above configuration of (1), the information processing apparatus 100 can dynamically change the processing condition in accordance with the travel environment, the processing condition affecting object extraction precision and the power consumption and heat generation of the arithmetic unit (FPGA 170).

It is thus expected that the mileage of the electric vehicle is increased to be longer than that in the configuration of (1) and the cooling cost of the arithmetic unit (FPGA 170) is reduced.

(3) The information processing apparatus according to (1), further comprising a load detection device (50) that detects a computation load of the arithmetic unit (170), wherein the processing content control unit (120) includes a processing condition determining unit (122) that receives the computation load from the load detection device (50) and that compares a preset load threshold with the computation load to determine a load state, and wherein the execution layer determining unit (121) determines the number of the layers to be used by the DNN processing unit (110), based on the a determination result from the processing condition determining unit (122).

According to the above configuration, a load state according to a load of the FPGA 170 included in the information processing apparatus 100 is determined, and the execution layer determining unit 121 can dynamically change a processing condition according to the load. As a result, compared with the configuration of (1), the information processing apparatus 100 can dynamically reduce power consumption of the FPGA 170 and suppress heat generation of the same as well.

In addition, the information processing apparatus 100 of this embodiment with the above advantages prevents a problem with the FPGA 170 caused by thermal runaway or the like, thus being able to prevent a drop in the computation precision of the arithmetic unit. Hence, compared with the first embodiment, the mileage of the electric vehicle can be increased as the cooling cost of the FPGA 170 and the like can be reduced.

(4)

The information processing apparatus according to (2), further comprising a load detection device (50) that detects a computation load of the arithmetic unit (170), wherein the processing condition determining unit (122) receives the computation load from the load detection device (50), compares a preset load threshold with the computation load to determine a load state, and outputs a result of determination of the external environment and a result of determination of the load state to the execution layer determining unit (121), and wherein the execution layer determining unit (121) determines the number of the layers to be used by the DNN processing unit (110), based on a determination result from the processing condition determining unit (122).

According to the above configuration, the processing condition determining unit 122 determines a traveling environment and a load state, based on information indicating a traveling state and on a computation load of the FPGA 170. Thus, compared with the configurations of (2) and (3), object extraction precision and the extent of reduction of power consumption and heat generation can be changed dynamically. It is thus expected that an effect combining advantages of the configurations of (2) and (3) is achieved. In other words, it is possible that the load of the FPGA 170 is kept in a normal state as proper object extraction precision is maintained in various traveling environments.

(5) The information processing apparatus according to (4), wherein the processing content control unit (120) further includes: a recognition sensor unit (140) that receives sensor information (output from a LiDAR 400) for detecting an object and recognizes the object from the received sensor information; and a recognition precision determining unit (150) that calculates recognition precision by comparing an object recognized by the recognition sensor unit (140) with an object extracted by the DNN processing unit (110), the recognition precision determining unit (150) determining that the recognition precision has dropped when the recognition precision is equal to or lower than a preset precision threshold, wherein the processing condition determining unit (122) adds a determination result from the recognition precision determining unit (150) to a result of determination of the external environment and a result of determination of the load state, and outputs the determination results after the addition, to the execution layer determining unit (121), and wherein the execution layer determining unit (121) determines the number of the layers to be used by the DNN processing unit (110), based on a determination result from the processing condition determining unit (122).

According to the above configuration, by additionally providing the recognition sensor unit 140 that recognizes an object, based on information from the LiDAR 400, and the recognition precision determining unit 150 that determines the precision of object extraction by the object extracting unit 111 and the recognition sensor unit 140, excessive reduction in computation processes (layers), the excessive reduction making object extraction precision required for autonomous driving insufficient at the object extracting unit 111, can be prevented. As a result, the information processing apparatus 100 can maintain processing with precision higher than the precision of processing in the configurations of (1), (2), (3), and (4). Hence power consumption can be reduced further than in the configurations of (1), (2), (3), and (4).

(6) The information processing apparatus according to (2), wherein the external information is image information, wherein the processing content control unit (120) further includes an information amount determining unit (123) that determines an information amount of the image information, based on a determination result from the processing condition determining unit (122), and wherein the DNN processing unit (110) further includes an external information converting unit (112) that based on the information amount determined by the information amount determining unit (123), changes an information amount of the image information used by the object extracting unit (111).

According to the above configuration, the DNN processing unit 110 dynamically changes the number of pixels of an input image, based on a determination result from the processing condition determining unit 122, thus being able to use an image of which the number of pixels is matched to the number of execution layers of the DNN used by the object extracting unit 111. Thus, the number of execution layers of the DNN is reduced and the number of pixels of an image used by the object extracting unit 111 is reduced as well, which, therefore, allows a reduction in the amount of computations. As a result, power consumption is reduced and heat generation is suppressed more effectively than in the configurations of (1), (2), (3), and (4). It is thus expected that the mileage of the electric vehicle is increased to be longer than that in the configurations of (1), (2), (3), and (4) and that the cooling cost of the FPGA 170 or the like is reduced.

It should be noted that the present invention is not limited to the above embodiments but includes various modifications.

For example, the above embodiments have been described in detail for easy understanding of the present invention, and are not necessarily limited to embodiments including all constituent elements described herein. Some constituent elements of a certain embodiment may be replaced with constituent elements of another embodiment, and a constituent element of another embodiment may be added to a constituent element of a certain embodiment. In addition, some constituent elements of each embodiment may be added to, deleted from, or replaced with constituent elements of anther embodiment, and such addition, deletion, and replacement may be implemented separately or in a combined form.

Some or all of the above constituent elements, functions, processing units, processing means, and the like may be provided as hardware, such as properly designed integrated circuits. In addition, the above constituent elements, functions, and the like may be provided as software-based programs by causing a processor to interpret and execute programs for implementing the constituent elements and functions. Information for implementing functions, such as programs, tables, and files, may be stored in a storage device, such as a memory, a hard disk, and a solid state drive (SSD), or in a recording medium, such as an IC card, an SD card, and a DVD.

A group of control lines/information lines considered to be necessary for description are illustrated, and all control lines/information lines making up the product are not necessarily illustrated. It is safe to assume that, actually, almost the entire constituent elements are interconnected.

<Supplementary>

Described below are typical aspects of the present invention that are not disclosed in claims.

<7>

An information processing apparatus including a processor, a memory, and an arithmetic unit that executes a computation using an inference model, the information processing apparatus comprising: a DNN processing unit that receives external information, the DNN processing unit extracting an external object from the external information, using the inference model; and a processing content control unit that controls processing content of the DNN processing unit, wherein the DNN processing unit segments the external information into a plurality of block areas for extracting objects of different sizes, the DNN processing unit having an object extracting unit including the inference model, the object extracting unit extracting the external object in each of the block areas, using a deep neural network, and wherein the processing content control unit includes a block area determining unit that determines the block area used by the object extracting unit.

<8>

The information processing apparatus according to <7>, wherein the processing content control unit includes a processing condition determining unit that receives external state information, the processing condition determining unit comparing a preset threshold with a value of the external state information and determining an external environment, and wherein the block area determining unit determines the block area to be used by the DNN processing unit, based on a determination result from the processing condition determining unit, and outputs the determined block area to the DNN processing unit.

<9>

The information processing apparatus according to <7>, further comprising a load detection device that detects a computation load of the arithmetic unit, wherein the processing content control unit includes a processing condition determining unit that receives the computation load from the load detection device, the processing condition determining unit comparing a preset load threshold with the computation load to determine a load state, and wherein the block area determining unit determines the block area to be used by the DNN processing unit, based on a determination result from the processing condition determining unit.

<10>

The information processing apparatus according to <8>, further comprising a load detection device that detects a computation load of the arithmetic unit, wherein the processing condition determining unit receives the computation load from the load detection device, compares a preset load threshold with the computation load to determine a load state, and outputs a result of determination of the external environment and a result of determination of the load state to the block area determining unit, and wherein the block area determining unit determines the block area to be used by the DNN processing unit, based on a determination result from the processing condition determining unit.

<11>

The information processing apparatus according to <10>, wherein the processing content control unit further includes: a recognition sensor unit that receives sensor information for detecting an object and recognizes the object from the received sensor information; and a recognition precision determining unit that calculates recognition precision by comparing an object recognized by the recognition sensor unit with an object extracted by the DNN processing unit, the recognition precision determining unit determining that recognition precision has dropped when the recognition precision is equal to or lower than a preset precision threshold, wherein the processing condition determining unit adds a determination result from the recognition precision determining unit to a result of determination of the external environment and a result of determination of the load state, and outputs the determination results after the addition, to the block area determining unit, and wherein the block area determining unit determines the block area to be used by the DNN processing unit, based on a determination result from the processing condition determining unit.

<12>

The information processing apparatus according to <8>, wherein the external information is image information, wherein the processing content control unit further includes an information amount determining unit that determines an information amount of the image information, based on a determination result from the processing condition determining unit, and wherein the DNN processing unit further includes an external information converting unit that changes an information amount of the image information used by the object extracting unit, based on the information amount determined by the information amount determining unit.

### REFERENCE SIGNS LIST

100 information processing apparatus
110 DNN processing unit
111 object extracting unit
112 external information converting unit
120 processing content control unit
121 execution layer determining unit
122 processing condition determining unit
123 information amount determining unit
124 block area determining unit
130 action planning unit
140 recognition sensor unit
150 extraction precision determining unit
200 camera
300 vehicle control unit
400 LiDAR

1. An information processing apparatus including a processor, a memory, and an arithmetic unit that executes a computation using an inference model, the information processing apparatus comprising:
a DNN processing unit that receives external information, the DNN processing unit extracting an external object from the external information, using the inference model; and
a processing content control unit that controls processing content of the DNN processing unit,
wherein the DNN processing unit includes an object extracting unit that executes the inference model in a deep neural network having a plurality of layers of neurons, and
wherein the processing content control unit includes an execution layer determining unit that determines the layers used by the object extracting unit.

2. The information processing apparatus according to claim 1,
wherein the processing content control unit includes a processing condition determining unit that receives external state information, the processing condition determining unit comparing a preset threshold with a value of the external state information and determining an external environment, and
wherein the execution layer determining unit determines a number of the layers to be used by the DNN processing unit, based on a determination result from the processing condition determining unit, and outputs the determined number of the layers to the DNN processing unit.

3. The information processing apparatus according to claim 1,
further comprising a load detection device that detects a computation load of the arithmetic unit,
wherein the processing content control unit includes a processing condition determining unit that receives the computation load from the load detection device and that compares a preset load threshold with the computation load to determine a load state, and
wherein the execution layer determining unit determines a number of the layers to be used by the DNN processing unit, based on the a determination result from the processing condition determining unit.

4. The information processing apparatus according to claim 2, further comprising a load detection device that detects a computation load of the arithmetic unit,
wherein the processing condition determining unit receives the computation load from the load detection device, compares a preset load threshold with the computation load to determine a load state, and outputs a result of determination of the external environment and a result of determination of the load state to the execution layer determining unit, and
wherein the execution layer determining unit determines a number of the layers to be used by the DNN processing unit, based on a determination results from the processing condition determining unit.

5. The information processing apparatus according to claim 4,
Wherein the processing content control unit further includes:
a recognition sensor unit that receives sensor information for detecting an object and recognizes the object from the received sensor information; and
a recognition precision determining unit that calculates recognition precision by comparing an object recognized by the recognition sensor unit with an object extracted by the DNN processing unit, the recognition precision determining unit determining that recognition precision has dropped when the recognition precision is equal to or lower than a preset precision threshold,
wherein the processing condition determining unit adds a determination result from the recognition precision determining unit to the result of determination of the external environment and the result of determination of the load state, and outputs the determination results after the addition, to the execution layer determining unit, and
wherein the execution layer determining unit determines a number of the layers to be used by the DNN processing unit, based on a determination result from the processing condition determining unit.

6. The information processing apparatus according to claim 2,
wherein the external information is image information,
wherein the processing content control unit further includes an information amount determining unit that determines an information amount of the image information, based on a determination result from the processing condition determining unit, and
wherein the DNN processing unit further includes an external information converting unit that changes an information amount of the image information used by the object extracting unit, based on the information amount determined by the information amount determining unit.
